(19) United States
(12) Patent Application Publication
(10) Pub. No.: US 2021/0069708 A1
(43) Pub. Date: Mar. 11, 2021

(54) MICROFLUIDIC FLOW SENSOR

(71) Applicant: HEWLETT-PACKARD DEVELOPMENT COMPANY, L.P., Spring, TX (US)

(72) Inventors: Alexander N. GOVYADINOV, Corvallis, OR (US); Pavel KORNILOVICH, Corvallis, OR (US); Diane R. HAMMERSTAD, Corvallis, OR (US)

(73) Assignee: HEWLETT-PACKARD DEVELOPMENT COMPANY, L.P., Spring, TX (US)

(21) Appl. No.: 16/772,350

(22) PCT Filed: Feb. 12, 2018
(86) PCT No.: PCT/US2018/017808

§ 371 Date: Jun. 12, 2020

(51) Int. Cl. B01L 3/00; G01F 1/708; B01F 3/04

(52) U.S. Cl. CPC B01L 3/502715; G01F 1/7088; B01F 3/04106; B01L 2300/0663; G01F 1/7084; G01F 1/7086; G01F 1/7082

(57) ABSTRACT

A microfluidic flow sensor may include a substrate having a microfluidic channel, a bubble generator to introduce a bubble into fluid that is directed through the microfluidic channel and a sensor element along the microfluidic channel and spaced from the bubble generator. The sensor element outputs a signal based upon a sensed passage of the bubble with respect to the sensor element. Portions of the microfluidic channel proximate the sensor element have a first size and wherein the bubble generated by the bubble generator is to have a second size greater than one half the first size.

### BACKGROUND

Microfabrication involves the formation of structures and various components on a substrate (e.g., silicon chip, ceramic chip, glass chip, etc.). Examples of microfabricated devices include microfluidic devices. Microfluidic devices include structures and components for conveying, processing, and/or analyzing fluids as well as the chemical and/or biochemical reactions involving such fluids.

### BRIEF DESCRIPTION OF THE DRAWINGS

FIG. 1 is a schematic diagram illustrating portions of an example microfluidic flow sensor.

FIG. 2 is a flow diagram of an example method for sensing fluid flow.

FIG. 3 is a schematic diagram of portions of an example fluidic die incorporating an example microfluidic flow sensor.

FIG. 4 is a schematic diagram of portions of an example fluidic die incorporating an example microfluidic flow sensor.

FIG. 5 is a schematic diagram of portions of an example fluidic die incorporating an example microfluidic flow sensor.

FIG. 6 is a schematic diagram of portions of an example fluidic die incorporating an example microfluidic flow sensor.

FIG. 7 is a schematic diagram of portions of an example fluidic die incorporating an example microfluidic flow sensor.

FIG. 8 is a schematic diagram of portions of an example fluidic die incorporating an example microfluidic flow sensor.

FIG. 9 is a top view schematically illustrating portions of an example fluidic die incorporating an example microfluidic flow sensor.

FIG. 10 is a sectional view schematically illustrating portions of the example fluidic die of FIG. 9.

FIG. 11 is a schematic diagram of portions of an example fluidic die incorporating an example microfluidic flow sensor.

FIG. 12 is a schematic diagram of portions of an example fluidic die incorporating an example microfluidic flow sensor.

FIG. 13 is a schematic diagram of portions of an example fluidic die incorporating an example microfluidic flow sensor.

FIG. 14 is a schematic diagram of portions of an example fluidic die incorporating an example microfluidic flow sensor.

FIG. 15 is a schematic diagram of portions of an example fluidic die incorporating an example microfluidic flow sensor.

FIG. 16 is a sectional view schematically illustrating portions of an example fluidic die incorporating an example microfluidic flow sensor.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

In many applications, the flow of a fluid in a microfluidic device is sensed or measured. Disclosed herein are example microfluidic flow sensors and methods that facilitate the sensing of fluid flow in a microfluidic device. The example microfluidic flow sensors and methods sense fluid flow without the introduction of particles or other materials that may interact with or alter the nature or chemical composition of the fluid.

The example microfluidic flow sensors and methods generate and introduce a bubble into fluid that is directed through a microfluidic channel of the microfluidic device, wherein passage of the bubble along the microfluidic channel is sensed. Portions of the microfluidic channel proximate the sensor element have a first size and wherein the bubble generated by the bubble generator is controlled to have a second size greater than one half the first size. As a result, the flow of such sized bubbles occurs in a single file flow or serial fashion through a sensing region of the sensor that detects the bubble. The single file flow or serial flow of such bubbles facilitate more accurate detection of the bubbles and more accurate determination of fluid flow rate.

In one implementation, the creation of the bubbles is controlled such that each of the generated bubbles has a size, a diameter, greater than one half the corresponding size of those bubble sensing portions of the microfluidic channel, those portions of the microfluidic channel where the bubble sensors are located. For example, in one implementation where the bubbles are created using a thermal resistor, the amount of heat or the rate at which heat is generated to form the bubble may be controlled to control the size of the bubbles being created.

In another implementation, the creation of bubbles is less controlled such as where the bubble generator may generate or output bubbles of different sizes, wherein some of the bubbles are greater than one half the size of the sensing regions of the microfluidic channel and wherein other bubbles are smaller than one half the size of the sensing regions of the microfluidic channel. In such an implementation, although those smaller bubbles may overlap or proceed along the channel in a parallel fashion with one another or with bubbles having a size greater than one half the sizes sensing region of the microchannel, such smaller bubbles are not considered or are disregarded when determining a flow rate. For example, in one implementation, a controller may receive signals from a bubble sensing device and determine the size of each of the bubbles. The controller may then compare the determined size of each bubble to a predetermined threshold, such as a threshold corresponding to one half the size of the bubble sensing regions of the microfluidic channel. When determining a flow rate or other determination using such bubbles, the controller may disregard those bubbles having a size less than or equal to the threshold, considering just those bubbles that meet the criteria that each individual bubble used in flow rate determinations or other determinations have a size greater than one half the size of the sensing region of the microfluidic channel.

In some implementations, the controller may count the number of bubbles failing to meet the size criteria. In one implementation, in response to the number of bubbles failing to meet the size criteria (>½ the size of the sensing region of the channel), the percentage of bubbles failing to meet the size criteria for the number of bubbles during a predetermined period of time failing to meet the size criteria, the controller may adjust the operational parameters of the bubble generator such that the bubbles a greater percentage or number of the bubbles generated satisfy the size criteria.

In one implementation, the bubble may be introduced directly into the microfluidic channel, introduced into a stream of fluid that is presently flowing through the microfluidic channel. In another implementation, the bubble may be introduced into a volume of fluid external to the microfluidic channel or into fluid within the microfluidic channel but not yet moving through the microfluidic channel, wherein the fluid and the entrained bubble is subsequently pumped or otherwise allowed to flow (such as under the force of gravity or capillary forces) through the microfluidic channel.

In one implementation, a controller controls a size of the bubble and to generate two different bubbles having different sizes, wherein both sizes are greater than one half the size of portions of the channel at which bubbles are sensed. In such an implementation, the controller may control at least one of a timing and an order at which the bubble and the second bubble are introduced into the fluid to serve as a tag or tracer which may be utilized to identify a selected portion of the stream as it travels along the microfluidic channel. In some implementations, the introduced bubble may identify a beginning of a selected portion of the stream, the end of a selected portion of the stream or other points along the stream. In some implementations, multiple bubbles may be introduced into the stream to identify a start of a selected portion of the stream and an end of the selected portion of the stream.

In some implementations, a stream or flow of fluid in the microfluidic device may change over time or may have different compositions or material properties along its length. Different portions of the stream of fluid may have different properties. In some implementations, different portions of an overall stream are to be interacted upon differently or are to be directed along different paths or to different destinations. A bubble introduced into a selected portion of the stream may be sensed to identify where the selected portion of the stream presently resides along the microfluidic channel. The sensed location of the bubble may be used to trigger changes in the way that different portions of the fluid stream are interacted upon. In implementations where multiple portions are tagged with multiple bubbles, the sensed bubbles may be counted, wherein the count value of a particular bubble indicates what portion of the stream is associated with the bubble and where the portion of stream resides in the microfluidic channel. For example, a first bubble may correspond to a first portion of the stream, a second bubble may correspond to a second portion of the stream and so on.

In some implementations, a microfluidic die may have a fluid device at a certain location along a microfluidic channel that is to interact with a selected portion of the stream of fluid or is to differently interact with different portions of the stream. The location of the introduced bubble along the channel may be sensed and identified to determine when a selected portion of the stream of fluid has arrived at the fluid device, is about to arrive at the fluid device or is about to leave the fluid device. The location of the introduced bubble along the microfluidic channel relative to the location of the fluid device along the microfluidic channel may trigger a change in the status of the fluid device. For example, the sensed arrival of the bubble at the fluid device may cause the fluid device to be turned off, to be turned on or to have a change in its operating parameters. The sensed departure of the bubble from the region of the microfluidic channel having the fluid device may cause the fluid device to be turned on, to be turned off or to have a change in its operating parameters. Signals from a sensor indicating that the bubble is about to arrive at the fluid device (within a certain distance or time from the fluid device), may cause the fluid device to turn on, allowing time for the fluid device to warm up or otherwise ready itself for the arrival of the bubble and the associated portion of the fluid stream.

In some implementations, the sensed location of the bubble may trigger a change in a fluid device in the form of a mixer that mixes or circulates a fluid. In some implementations, the sensed location of the bubble may trigger a change in a fluid device in the form of a fluid ejector that ejects fluid from the microfluidic passage. In some implementations, a sensed location of the bubble may trigger a change in a fluid device in the form of a dispenser that adds or dispenses additional material or fluid into the stream of fluid. In some implementations, a sensed location the bubble may trigger a change in a fluid device in the form of a microfluidic valve mechanism that selectively blocks fluid, allows the passage of fluid or that selectively directs fluid through one of various available paths. In some implementations, a sensed location of the bubble may trigger a change in a fluid device in the form of a heater that generates and applies heat to at least portions of the fluid stream. In some implementations, a sensed location of the bubble may trigger a change in a fluid device in the form of a sensor that senses at least one property of the fluid. In some implementations, a sensed location of the bubble may trigger a change in a fluid device in the form of a pump that drives fluid along the microfluidic channel.

In some implementations, the size of the bubble may be controlled, wherein multiple bubbles of different controlled sizes are generated and introduced into the fluid which is to presently or subsequently form a fluid stream. The timing and/order at which the differently sized bubbles are introduced into the fluid may be controlled so as to tag or mark a starting point and an endpoint of a portion of the fluid stream or so as to mark or tag different portions of a fluid stream. The differently sized bubbles are detected and distinguished from one another, allowing identification of the starting point and the endpoint of a portion of a fluid stream or allowing identification of different portions of the fluid stream.

In some implementations, the sensed location of the bubble may be used to measure a flow rate, the speed at which the fluid is flowing along the microfluidic channel. In one implementation, the flow rate may be determined by dividing the distance from the location at which the bubble was generated to the location at which the bubble was later sensed by the amount of time elapsed from when the bubble was generated to when the bubble was later sensed. In other implementations, the flow rate may be determined by sensing the location of the bubble at two different locations along the microfluidic channel, wherein the flow rate may be determined by dividing distance between the two locations at which the bubble was sensed by the amount of time elapsed from when the bubble was first sensed at the first location to when the bubble was later sensed at the second location.

In some implementations, the microfluidic flow sensors and methods provide precise and fast speed measurements across a wide range of fluid flow rates or speeds, low flow rates and high flow rates. In some implementations, the microfluidic flow sensors and methods comprise a sensor element, a second sensor element and a third sensor element, in series, wherein the first and second sensor elements are spaced apart from one another by a first distance and wherein the second and third sensor elements are spaced apart from one another by a second distance different than the first distance. In one implementation, the sensor elements are arranged in an array. In another implementation, sensor elements are arranged in a log scale array.

The determined speed or fluid flow rate may be utilized to provide closed-loop feedback regarding the movement of fluid along the microfluidic channel. For example, the determined fluid flow rate may be compared to certain predefined thresholds, wherein the comparison may trigger a change in the rate at which the fluid is moved along the microfluidic channel. The determined fluid flow rate may cause a change in the operating parameters of a fluid pump or a change in the operating parameters of multiple fluid pumps. The determined fluid flow rate may cause a change in constrictions or filters through which the fluid flows.

In some implementations, the determined speed or fluid flow rate may be utilized to trigger changes in the manner in which a fluid device along the microfluidic channel interacts with the stream of fluid. For example, the determined fluid flow rate may be compared to certain predefined thresholds, wherein the comparison may trigger a fluid device, such as those described above, to differently interact with the stream of fluid. The operating parameters of fluid devices in the form of a fluid ejector, a material or fluid dispenser, a fluid mixer, and microfluidic valve mechanism, a heater or an additional sensor may be changed in response to or based upon the determined fluid flow rate. The determined fluid flow rate may cause a change in the timing at which the fluid device is turned on or off based upon the expected time of arrival and/or departure of a target portion of the stream given the fluid flow rate.

The disclosed microfluidic flow sensors and methods may utilize a variety of different sensor elements to detect the presence or passage of a bubble relative to the sensor element or elements. Examples of such sensor elements include, but are not limited to, optical emitter-detector sensors, electrical impedance sensors, capacitance sensors, acoustic sensors, thermal sensors and the like.

As will be appreciated, examples provided herein may be formed by performing various microfabrication and/or micromachining processes on a substrate to form and/or connect structures and/or components. Substrates forming the microfluidic flow sensors may comprise a silicon based wafer or other such similar materials used for microfabricated devices (e.g., glass, gallium arsenide, plastics, etc.). Examples may comprise microfluidic channels, fluid actuators, and/or volumetric chambers. Microfluidic channels and/or chambers may be formed by performing etching, microfabrication processes (e.g., photolithography), or micromachining processes in a substrate. Accordingly, microfluidic channels and/or chambers may be defined by surfaces fabricated in the substrate of a microfluidic device. In some implementations, microfluidic channels and/or chambers may be formed by an overall package, wherein multiple connected package components combine to form or define the microfluidic channel and/or chamber.

In some examples described herein, at least one dimension of a microfluidic channel and/or capillary chamber may be of sufficiently small size (e.g., of nanometer sized scale, micrometer sized scale, millimeter sized scale, etc.) to facilitate pumping of small volumes of fluid (e.g., picoliter scale, nanoliter scale, microliter scale, milliliter scale, etc.). For example, some microfluidic channels may facilitate capillary pumping due to capillary force. In addition, examples may couple at least two microfluidic channels to a microfluidic output channel via a fluid junction.

The microfluidic channels may facilitate conveyance of different fluids (e.g., liquids having different chemical compounds, different physical properties, different concentrations, etc.) to the microfluidic output channel. In some examples, fluids may have at least one different fluid characteristic, such as vapor pressure, temperature, viscosity, density, contact angle on channel walls, surface tension, and/or heat of vaporization. It will be appreciated that examples disclosed herein may facilitate manipulation of small volumes of liquids.

Disclosed herein is an example microfluidic flow sensor that comprises a substrate having a microfluidic channel, a bubble generator to introduce a bubble into fluid flowing through the microfluidic channel and a sensor element along the microfluidic channel and spaced from the bubble generator. The sensor element outputs a signal based upon a sensed passage of the bubble with respect to the sensor element. Portions of the microfluidic channel proximate the sensor element have a first size and wherein the bubble generated by the bubble generator is controlled to have a second size greater than one half the first size

Disclosed herein is an example microfluidic flow sensor that may comprise a substrate having a microfluidic channel and a bubble generator to generate and introduce a bubble into fluid that is directed (presently or in the future) through the microfluidic channel. The bubble generator may comprise an electrical resistor supported by the substrate, wherein the electrical resistor, upon conducting electrical current, generates heat to vaporize portions of the fluid to create a bubble or to form a bubble from dissolved in fluid air. The microfluidic flow sensor may further comprise a first sensor element along the microfluidic channel downstream the bubble generator, the first sensor element to output a first signal based upon a sensed passage of the bubble with respect to the first sensor element and a second sensor element along the microfluidic channel downstream the bubble generator and upstream the first sensor element. The second sensor element is to output a second signal based upon a sensed passage of the bubble with respect to the second sensor element. A controller may determine a flow rate of the fluid based upon the first signal from the first sensor element and the second signal from the second sensor element.

Disclosed herein is an example method for sensing fluid flow through a microfluidic channel with a microfluidic flow sensor. The method may comprise generating a bubble and introducing the bubble into a fluid that is directed through the microfluidic channel and sensing passage of the bubble along the microfluidic channel.

FIG. 1 schematically illustrates portions of an example microfluidic flow sensor 20. Flow sensor 20 senses fluid flow without the introduction of particles or other materials that may interact with or alter the nature or chemical composition of the fluid. Flow sensor 20 generates and introduces a bubble into fluid that is directed through a microfluidic channel of the microfluidic device, wherein passage of the bubble along the microfluidic channel is sensed. In one implementation, the bubble may be introduced directly into the microfluidic channel, introduced into a stream of fluid that is presently flowing through the microfluidic channel. In another implementation, the bubble may be introduced into a volume of fluid external to the microfluidic channel or into fluid within the microfluidic channel but not yet moving through the microfluidic channel, wherein the fluid and the entrained bubble is subsequently pumped or otherwise allowed to flow (such as under the force of gravity or capillary forces) through the microfluidic channel. Flow sensor 20 comprises substrate 24, bubble generator 28 and sensor element 32.

Substrate 24 comprises a structure formed from at least one layer in which a microfluidic channel 36 extends. Substrate 24 may comprise a silicon based wafer or other such similar materials used for microfabricated devices (e.g., glass, gallium arsenide, plastics, photoresists such as SU8, etc.). FIG. 1 illustrates a portion of microfluidic channel 36. Microfluidic channel 36 extends within substrate 24 and directs a stream of fluid. Microfluidic channel 36 may have a closed end or may be part of a continuous looping arrangement. Microfluidic channel 36 may extend from a reservoir and may extend to a reservoir or waste chamber. Microfluidic channel 36 may terminate at a nozzle through which fluid is ejected or may terminate at a slot or a second channel. In one implementation, channel 36 may be of sufficiently small size (e.g., of nanometer sized scale, micrometer sized scale, millimeter sized scale, etc.) to facilitate pumping of small volumes of fluid (e.g., picoliter scale, nanoliter scale, microliter scale, milliliter scale, etc.). Microfluidic channel 36 may be formed by performing etching, microfabrication processes (e.g., photolithography), or micromachining processes in a substrate.

Bubble generator 28 comprises a mechanism that generates and introduces a bubble 37 into fluid that is to form a stream 39 of fluid flowing through microfluidic channel 36. In one implementation, bubble generator 28 generates and introduces bubble 37 into fluid in a controlled and consistent fashion, wherein the size and/or timing at which the bubble is released may be controlled. In one implementation, bubble generator 28 generates a bubble having a controlled size with a diameter of at least one half a diameter (sometimes referred to as a channel hydraulic diameter) or a minor cross-sectional dimension of passage 36 such that multiple bubbles within stream 39 cannot pass one another and travel in single-file fashion along channel 36. In one implementation, bubble generator 28 generates a bubble having a controlled size with a diameter of at least 0.8 times the diameter or maximum cross-sectional dimension of passage 36 to enhance detection of the bubble by sensor element 32. In some implementations, microfluidic channel 36 has a constricted region or pinch point within the sensing zone of sensor element 32, wherein bubble generator 28 generates a bubble having a controlled size with a diameter greater than the diameter or at least one cross-sectional dimension of the constricted region or pinch point for enhanced bubble detection.

In one implementation, bubble generator 28 comprises a thermal resistor along microfluidic channel 39, wherein the thermal resistor, in response to being supplied with electrical current, generates sufficient quantities of heat so as to vaporize portions of the fluid within channel 36 to create an expanding bubble 37. The thermal resistor may also create a bubble 37 from dissolved air in the fluid. In another implementation, bubble generator 28 may comprise a pneumatic pump which pumps air or another inert gas into the fluid within microfluidic channel 36 so as to create a bubble 37. In yet other implementations, an electrochemical mechanism may be utilized to create a bubble 37. For example, bubble 37 may be formed from an electrochemical process, such as where two electrodes forming a cathode and an anode cause a fluid to undergo electrolysis to liberate hydrogen and/or oxygen from the fluid to form bubble 37. In yet other implementations, bubble generator 28 may comprise other mechanisms as to form a bubble of an inert gas within channel 36.

In one implementation, the bubble may be introduced into a stationary volume of fluid, whether residing within the microfluidic channel or within a reservoir or other volume from which fluid is drawn. In such an implementation, once formation of the bubble 37 has been completed, a valve is opened and/or a pump is initiated to move the fluid entraining the bubble within channel 36 as a stream. In other implementations, bubble 37 may be created by bubble generator 28 without interrupting the ongoing stream of fluid flowing within channel 36. Although schematically illustrated as being located along the side of channel 36, in some implementations, bubble generator 28 may be at an upstream end of channel 36, such as in or adjacent to a reservoir from which fluid is taken.

Sensor element 32 comprises a sensor that outputs signals indicating presence of bubble 36 within a sensing zone of sensor element 32. Sensor element 32 is located downstream from the bubble generator 28. Sensor element 32 outputs a signal based upon the sensed passage of bubble 37 with respect to sensor element 32.

In some implementations, in addition to indicating the presence of the bubble 37 at or within the sensing zone of sensor element 32, the signals from sensor element 32 may be used in combination with other information or other signals to determine a flow rate or speed of stream 39. For example, in one implementation, the flow rate of stream 39 may be determined by dividing the distance from the location at which the bubble 37 was generated by bubble generator 28 to the location at which the bubble 37 was later sensed by sensor element 32 by the amount of time elapsed from when the bubble was generated to when the bubble was later sensed. In other implementations, the flow rate may be determined by sensing the location of the bubble at two different locations along the microfluidic channel, wherein the flow rate may be determined by dividing distance between sensor element 32 and a second additional sensor element that sensed the presence of bubble 37 by the amount of time elapsed from when the bubble was first sensed by sensor element 32 to when the bubble was later sensed at the second sensor element downstream from sensor element 32. As discussed above, the presence of bubble 37 or the fluid flow rate determined in part based upon the presence of bubble 37 may be used in a variety of fashions to automatically adjust various fluid devices that interact with the fluid such as pumps, heaters, fluid ejectors, material or fluid dispensers, mixers, valve mechanisms and sensors that sense a characteristic or composition of fluid about the bubble.

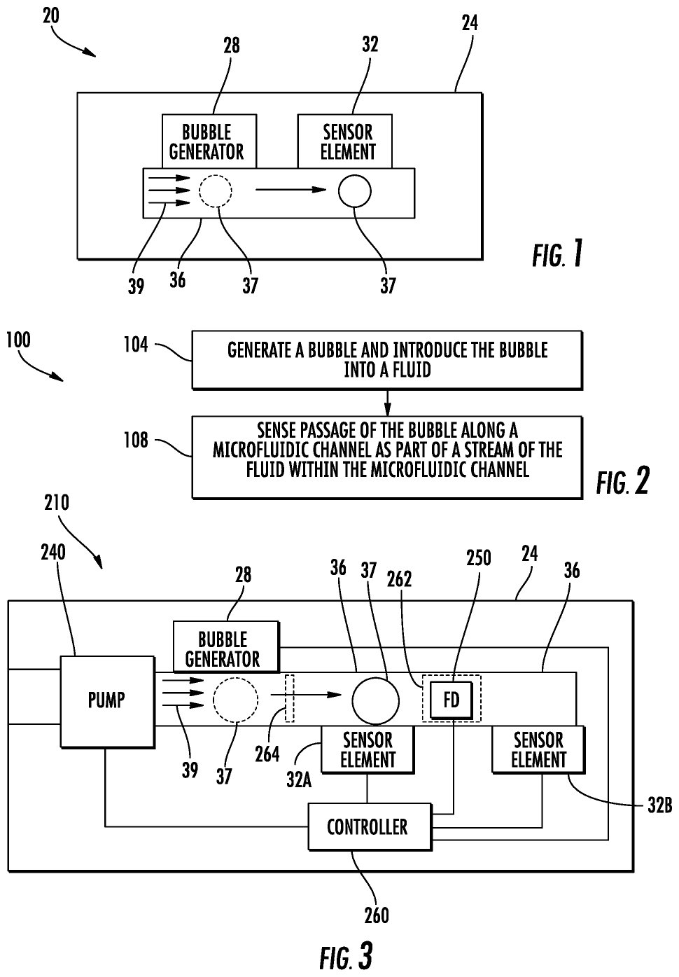

FIG. 2 is a flow diagram of an example method 100 for sensing fluid flow through the microfluidic channel. Method 100 senses fluid flow through microfluidic channel to determine where a portion of a stream may presently reside in a microfluidic channel are to determine a fluid flow rate. Method 100 senses fluid flow without introducing materials or fluids that may alter the chemical composition of the fluid. Although method 100 is described in the context of being carried out by microfluidic flow sensor 20, it should be appreciated that method 100 may carried out with any of the microfluidic flow sensors and fluidic dies described hereafter or with similar fluidic dies.

As indicated by block 104, bubble generator 28 generates a bubble and introduces the bubble 37 into a fluid. In one implementation, the bubble is generated and introduced into stagnant fluid, wherein the stagnant fluid is subsequently pumped or is subsequently allowed to flow, such as under the force of gravity, capillary forces and the like, as a stream within microfluidic channel 36. In other implementations, the generated bubble is introduced directly into a currently moving stream 39 of fluid.

In one implementation, the bubble being generated has a consistent and controlled size with a diameter of at least one half a diameter or a minor cross-sectional dimension of passage 36 such that multiple bubbles within stream 39 cannot pass one another and travel in single-file fashion along channel 36. In one implementation, the generated bubble has a controlled size with a diameter of at least 0.8 times the diameter or maximum cross-sectional dimension of passage 36 to enhance detection of the bubble by sensor element 32. In some implementations, microfluidic channel 36 has a constricted region or pinch point within the sensing zone of sensor element 32, wherein the generated bubble has a controlled size with a diameter greater than the diameter or at least one cross-sectional dimension of the constricted region or pinch point for enhanced bubble detection.

As indicated by block 108, the passage of the bubble along the microfluidic channel 36 as part of the stream within the microfluidic channel is sensed. For example, sensor element 32 may sense the presence of bubble 37 within its sensing zone and output signals indicating such presence. As discussed above, the signals output by sensor element 32 may be used to directly trigger a change in at least one fluid device along microfluidic channel 36 and/or may be used to determine a fluid flow rate or speed, wherein the determined flow rate or speed triggers a change in at least one fluid device along microfluidic channel 36. In some implementations, the determined fluid flow rate provides closed-loop feedback facilitating precise control over the actual fluid flow rate along a microfluidic channel 36.

FIG. 3 schematically illustrates portions of a fluidic die 210 that incorporates a microfluidic flow sensor similar to microfluidic flow sensor 20 described above. Fluidic die 210 comprises substrate 24, bubble generator 28, sensor elements 32A, 32B (collectively referred to as sensor elements 32), pump 240, fluid device 250 and controller 260. Substrate 24 is similar to substrate 24 described above, including a microfluidic channel 36 through which a stream 39 of fluid may flow in the direction indicated by the arrows. Bubble generator 28 is similar to bubble generator 28 of sensor 20 described above.

Sensor elements 32 are each similar to sensor element 32 described above. In the example illustrated, sensor element 32A is located proximate to an upstream side of fluid interaction zone 262 of fluid device 250. Sensor element 32B is located proximate to a downstream side of fluid interaction zone 262 of fluid device 250. The fluid interaction zone 262 is a region where fluid device 250 interacts with the stream 39 of fluid flowing through microfluidic passage 36. Zone 262 may be the region where fluid device 250 heats, pumps, senses, directs with a valve, mixes, ejects with a nozzle or supplements the fluid with additional materials or fluids.

Sensor element 32A indicates when the portion of the stream 39 containing bubble 37 has reached or arrived at fluid interaction zone 262. As described above, in some implementations, signals from sensor elements 32A indicating the arrival of the portion of stream 39 containing bubble 37 at zone 262 may trigger a change in the state of fluid device 250. Sensor element 32B indicates when the portion of the stream 39 containing bubble 37 is departing or moving away from fluid interaction zone 262. As described above, in some implementations, signals from sensor elements 32B indicating the departure of the portion of stream 39 containing bubble 37 from zone 262 may trigger a change in the state of fluid device 250. In some implementations, fluidic die 210 may omit one of sensor elements 32, such as where the arrival or departure time is not used to control fluid device 250.

Pump 240 comprises a device that displaces fluid so as to move fluid along microfluidic channel 36. In one implementation, pump 240 comprises an inertial pump. For example, pump 240 may comprise a fluid actuator asymmetrically located along microfluidic channel 36 with respect to a reservoir such that the fluid actuator, upon being actuated, pumps fluid away from the reservoir. Examples of a fluid actuator that may be utilized as part of an inertial pump include, but are not limited to, thermal actuators, piezo-membrane based actuators, electrostatic membrane actuators, mechanical/impact driven membrane actuators, magnetostrictive drive actuators, electrochemical actuators, external laser heaters, other such microdevices, or any combination thereof. In some examples, fluid actuators may be formed in microfluidic channels by performing various microfabrication processes. In other implementations, pump 240 may comprise other micro-electromechanical systems (MEMS) that form a fluidic pump.

Fluid device (FD) 250 comprises a device that interacts with the fluid within microfluidic channel 36. As described above, fluid device 250 may interact with fluid within a fluid interaction zone 262. Fluid device 250 (schematically shown) may comprise any one of a variety of different fluid devices such as a fluid mixer/agitator, a valve mechanism that blocks or redirects fluid, a fluid ejector having a fluid actuator (described above) that ejects fluid through a nozzle, a heater, a cooling device, a dispenser that dispenses a material or fluid into the stream within microfluidic channel 36, or an additional sensing device that senses a composition or characteristic, such as temperature, of the fluid adjacent or in close proximity to the bubble. For example, the sensing device forming fluid device 250 may comprise a temperature sensor, an optical sensor or another form of a fluid sensor.

Controller 260 comprises electronic circuitry, such as a processing unit or integrated circuit, that follows instructions contained in a non-transitory computer readable medium or logic. Controller 260 receives signals from and outputs control signals to each of bubble generator 28, sensor elements 32, pump 240 and fluid device 250. Controller 260 may output control signals causing method 100 to be carried out.

In one implementation, controller 260 outputs control signals causing bubble generator 28 to generate and introduce bubble 37. As described above, in one implementation, controller 260 may output control signals such that pump 240 is pumping or moving fluid at a reduced rate or is inactive such that the generated bubble is formed in a slow or stagnant volume of fluid. In one implementation, the bubble may be generated and introduced into a reservoir from which pump 240 draws fluid. In some implementations, an active or passive valve 264 may be located within passage 36 to block flow of fluid when bubble 37 is being generated, wherein the valve 264 is opened, either in response to fluid pressure generated by pump 240 or under active control in response to signals from controller 260 after bubble 37 has been generated. In other implementations, controller 260 may output control signals to pump 240 and bubble generator 28 such that bubble generator 28 introduces bubble 37 into an existing stream 39 of fluid.

In one implementation, controller 260 may control bubble generator 28 such that each of the generated bubbles has a size, a diameter, greater than one half the corresponding size of those bubble sensing portions of the microfluidic channel 36, those portions of the microfluidic channel where the bubble sensors are located. For example, in one implementation where bubble generator 28 comprises a thermal resistor, the amount of heat or the rate at which heat is generated to form the bubble may be controlled to control the size of the bubbles being created.

In another implementation, the creation of bubbles by the bubble generator 28 and/or controller 260 is less controlled such as where the bubble generator 28 may generate or output bubbles of different sizes, wherein some of the bubbles are greater than one half the size of the sensing regions of the microfluidic channel and wherein other bubbles are smaller than one half the size of the sensing regions of the microfluidic channel 36. In such an implementation, although those smaller bubbles may overlap or proceed along the channel 36 in a parallel fashion with one another or with bubbles having a size greater than one half the sizes sensing region of the microfluidic channel 36, such smaller bubbles are not considered or are disregarded when determining a flow rate. For example, in one implementation, controller 260 may receive signals from at least one of sensor elements 32 and may determine the size of each of the bubbles. The controller 260 may then compare the determined size of each bubble to a predetermined and stored threshold, such as a threshold corresponding to one half the size of the bubble sensing regions of the microfluidic channel 36. When determining a flow rate or other determination using such bubbles, the controller may disregard those bubbles having a size less than or equal to the threshold, considering just those bubbles that meet the criteria that each individual bubble used in flow rate determinations or other determinations have a size greater than one half the size of the sensing region of the microfluidic channel 36.

In one implementation, controller 260 outputs control signals controlling bubble generator 28 such that bubble generator 28 generates and outputs differently sized bubbles 37, wherein each of the different bubbles has a controlled size that is greater than one half the size of the bubble sensing regions of the microfluidic channel 36. The differently sized bubbles may result in sensor elements 32 outputting different electrical signals, wherein controller 260 may differentiate between the differently sized bubbles. For example, differently sized bubbles may cause different changes in impedance where sensor elements 32 each comprise an impedance sensor.

In such an implementation, the time at which the differently sized bubbles are introduced may be such that the differently sized bubbles identify or tag different portions of the stream of fluid. For example, a first portion of a stream of fluid may be tagged with a first sized bubble while a second portion of the stream of fluid, possibly having a different composition or characteristic, is tagged with a second sized bubble. With such different tagging of different portions, controller 36 may utilize signals from sensor elements 32 to identify what specific portion of the stream is presently entering, passing through and/are departing the sensing zone of the different sensing elements 32. In one implementation, a starting point and the endpoint of a single portion of the stream may be identified with differently sized bubbles, facilitating the identification of the ending point and starting point of a particular portion of a stream of fluid by controller 260.

Controller 260 receives signals from sensors 32 indicating the presence of bubble 37 as bubble 37 passes through the sensing zone of each of sensor elements 32. In one mode of operation, controller 260 may automatically output control signals that changes the operational status of fluid device 250 based upon the sensed presence of bubble 37 within the sensing zone of sensor element 32A. In one mode of operation, controller 260 may automatically output control signals a change the operational status of fluid device 250 based upon the sensed presence of bubble 37 within the sensing zone of sensor element 32B. Changes in the operational status of fluid device 250 may involve a change in the heat being output by device 250 within zone 262, may involve the frequency at which fluid drops are ejected through nozzle or the size of the fluid droplets being ejected through a nozzle from zone 262, may involve the sensing of characters the fluid proximate bubble 37, may involve the state of a valve or the direction in which fluid is directed by the valve within zone 262, may involve the frequency or rate at which the material or fluid is added to the stream within zone 262 or may involve the frequency or force by which the stream of fluid is mixed within the zone 262.

In another mode of operation, controller 260 may determine a fluid flow rate. The fluid flow rate may be determined based upon the time at which the bubble is generated by bubble generator 28 and its detection at either or both of sensor elements 32. The fluid flow rate may be determined based upon the time that it takes for bubble 37 to be sensed by sensor element 32A, travel to sensor element 32B and then be sensed by sensor element 32B, indicating the flow rate/speed of the fluid across fluid device 250.

Controller 260 may output control signals based upon the determined flow rate. For example, controller 260 may adjust the polling or sensing frequency of sensor elements 32 based upon the determined flow rate. Controller 260 may adjust other operational parameters of sensor elements 32 based upon the determined flow rate. Controller 260 may adjust the rate at which fluid is being pumped by pump 240 based upon the determined flow rate. Controller 260 may adjust the frequency at which bubbles are generated or the size of such bubbles being generated by bubble generator 28 based upon the determined flow rate. Controller 260 may adjust an operational parameter or status of fluid device 250 based upon the determined flow rate.

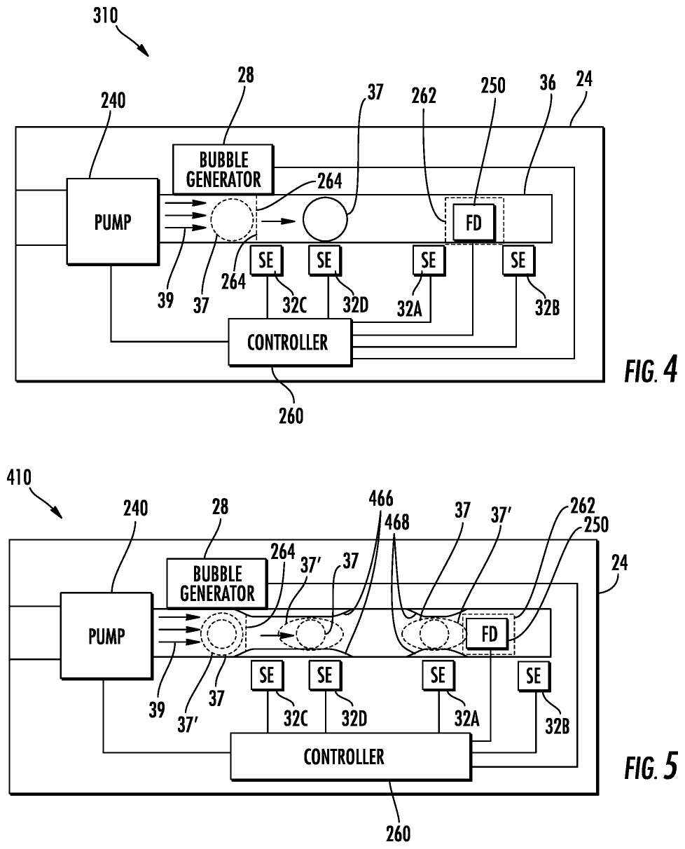

FIG. 4 schematically illustrates portions of another example fluidic die 310. Fluidic die 310 similar to fluidic die 210 except that fluidic die 310 additionally comprises sensor elements 32C and 32D. Sensor elements 32C and 32D are similar to sensor element 32 described above. Sensor element 32C and 32D are spaced from one another along a microfluidic channel 36 downstream of bubble generator 28 and upstream of sensor element 32A. Sensor element 32D is downstream from sensor element 32C. As with other sensor elements 32, sensor elements 32C and 32D each output signals in response to or based upon the presence of bubble 37 within the sensing zone of the respective sensor element.

Sensor elements 32C and 32D facilitate the detection of the presence of bubble 37 at two different locations upstream and prior to fluid interaction zone 262 of fluid device 250. Sensor elements 32C and 32D further facilitate the detection of the fluid flow rate upstream of sensor element 32A, independent of any fluid flow rate that may be determined using signals from sensors 32A and/or 32B.

Moreover, sensor elements 32C and 32D facilitate precise and fast speed measurements across a wide range of fluid flow rates or speeds, low flow rates and high flow rates. As shown by FIG. 4, sensor elements 32C and 32D are spaced apart from one another by a first distance while sensor elements 32D and 32A are spaced by a second distance greater than the first distance and while sensor elements 32C and 32A are spaced by a third distance greater than the second distance. In circumstances where the fluid flow rate is low, controller 260 may determine the fluid flow rate using signals from the closer sensors. In circumstances where the fluid for rate is high, above a predefined threshold, controller 260 may determine the fluid flow rate using signals from pairs of sensors that are farther apart, maintaining the timeliness of the determination of fluid flow rate along with the precision across the wide range of fluid flow rates. Controller 260 may determine which signals from which sensor elements to utilize based upon an initial determined fluid flow rate from any of the pair of sensors.

FIG. 5 schematically illustrates portions of another example fluidic die 410. Fluidic die 410 is similar to fluidic die 310 except that fluidic die 410 additionally comprises constrictions or pinch points 466, 468. Those remaining components of fluidic die 410 which correspond to components of fluidic die 310 are numbered similarly.

Pinch point 466 comprises a region of microfluidic channel 36 extending along or adjacent to sensing elements 32C and 32D, across their sensing zones, and having a reduced cross-sectional area or flow area (sometimes referred to as a hydraulic diameter or dimension). The reduced flow area results in bubble 37 occupying a larger percentage of pinch point 466 as compared to other regions of microfluidic passage 36 lacking such a pinch point. In one implementation, the pinch point has a hydraulic diameter of no greater than 80% of the hydraulic diameter of other regions of channel 36 which are not pinched). In one implementation, the constriction provided by pinch point 466 is sized such that bubble 37 occupies at least 80% of the hydraulic diameter or cross-sectional area of pinch point 466. In one implementation, the constriction provided by pinch point 466 is sized such that bubble 37 fully occupies the cross-sectional area of pinch point 466. In yet other implementations, the constriction provided by pinch point 466 is sized less than the corresponding dimension of bubble 37′ such that bubble 37′ is squeezed into an oval shape (as shown by broken lines in FIG. 5) as it passes through the pinch point 466. As the percentage of the pinch point 466 occupied by bubble 37, 37′ increases, the ability of sensor elements 32 to detect the presence of bubble 37, 37′ also increases.

Pinch point 468 is similar to pinch point 466 except that pinch point 468 extends across the sensing zone of sensor elements 32A. Pinch point 468 increases the bubble detecting performance of sensor element 32A. In some implementations, a pinch point similar to pinch points 466 and 468 may additionally be provided across the sensing zone of sensor element 32B.

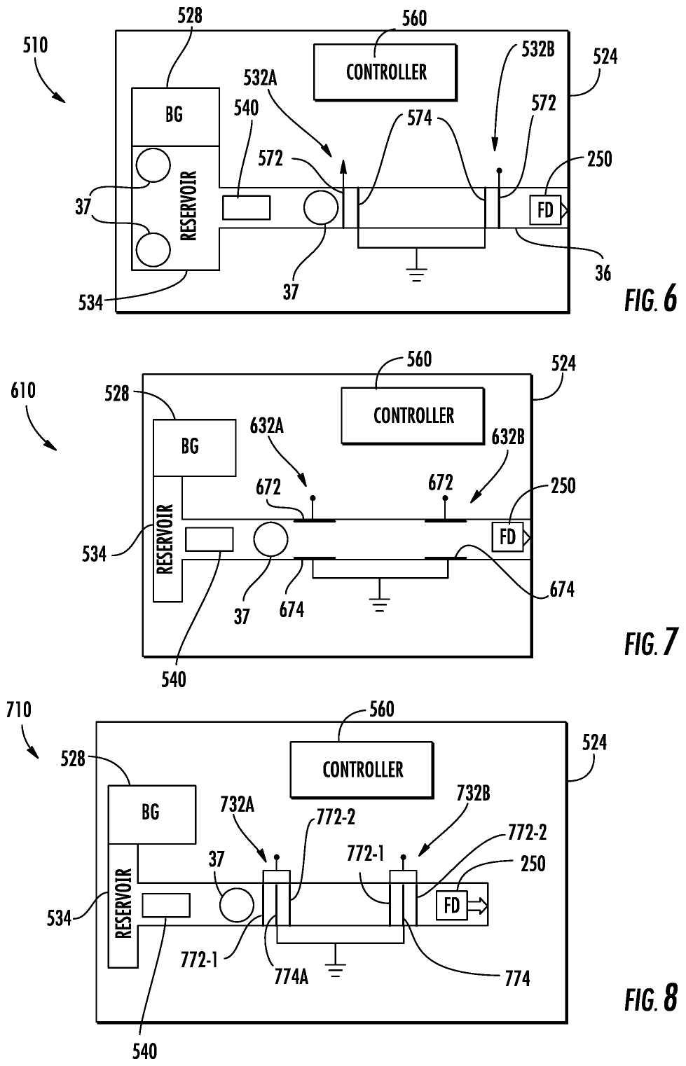

FIG. 6 schematically illustrates portions of an example fluidic die 510. Fluidic die 510 comprises substrate 524, bubble generator 528, sensor elements 532A, 532B (collectively referred to as sensor elements 532), pump 540, fluid device 250 (described above) and controller 560. Substrate 524 is similar to substrate 24 described above except that substrate 524 is specifically illustrated as comprising reservoir 534 in addition to microfluidic channel 36. Reservoir 534 comprises a chamber or volume fluidly connected to microfluidic channel 36 and from which fluid is drawn to form the stream of fluid flowing through channel 36.

Bubble generator 528 is similar to bubble generator 28 described above except the bubble generator 528 generates and specifically introduces bubbles 37 into reservoir 534. Bubble generator 528 provides bubble 37 having a consistent and controlled size, in contrast to haphazard and randomized bubbles. In one implementation, the diameter d of bubble 37 is controlled so as to be comparable to the channel hydraulic diameter D of passage 36. In one implementation, the size of each bubble 37 is controlled such that multiple bubbles within the stream cannot pass one another and travel in single-file fashion along channel 36. For example, each bubble has a controlled size of at least 0.5D. In one implementation, bubble generator 528 generates a bubble having a controlled size with a diameter of at least 0.8 times the diameter or maximum cross-sectional dimension of passage 36 to enhance detection of the bubble by sensor element 32. Small bubbles may not indicate or be representative for average flow. In some implementations, microfluidic channel 36 has a constricted region or pinch point within the sensing zone of sensor elements 532. In one implementation, the pinch point has a hydraulic diameter of no greater than 0.8D (no greater than 80% of the hydraulic diameter of other regions of channel 36 which are not pinched). In some implementations, bubble generator 528 generates a bubble having a controlled size with a diameter greater than or equal to the diameter or at least one cross-sectional dimension of the constricted region or pinch point for enhanced bubble detection.

Sensor elements 532 are similar to sensor elements 32C and 32D except that sensor elements 532 are each specifically illustrated as comprising sensor elements in the form of impedance sensors. Sensor elements 532 are spaced from one another along microchannel 36 by a sensor spacing. The sensor spacing may be chosen based upon the anticipated fluid flow rate range and a target response time for determining fluid flow rate.

Each of sensor elements 532 outputs signals based upon changes in electrical impedance brought about by the presence of a bubble 37 flowing through the sensing zone of the sensor element 532 and impacting impedance of the electrical field across or within the sensing zone. In one implementation, each of sensor elements 532 comprises an electrically charged high side electrode 572 and a low side electrode formed within or integrated within a surface of channel 36, consecutive electrodes 572 and 574 forming the sensing zone for the sensor element. In one implementation, electrodes 572, 574 comprise thin strips or segments of electrically conductive material comes such as metal. The sensing zone contains an electric field between high side electrode 572 and low side electrode 574. The presence of a bubble 37 interrupts or obstructs electric field lines such that the presence of a bubble is characterized by the electrical signals from electrode 572, representing changes in impedance, have longer ramp ups and ramp downs.

In one implementation, the low side electrode 574 is electrically grounded. In one implementation, both electrodes may be biased for impedance sensing. Electrodes 572 and 574 extend across microfluidic channel 32 at spaced locations in a serial fashion, being spaced from one another in a direction along channel 36. The spacing of electrodes 572 and 574 of each of sensor elements 532 is comparable to the diameter d of bubble 37. In one implementation, the electrode spacing is at least 0.2d and no greater than 2d. It should be appreciated that the order of electrodes 572 and 574 of each sensor elements 532 illustrated in FIG. 6 may be reversed. Each of the electrically charged electrodes 574 is electrically coupled to controller 560, directly or indirectly, such that controller 560 may sense changes in the impedance impacting electrical current flow through electrodes 572.

Pump 540 is similar to pump 240 described above except that pump 540 is specifically illustrated as extending adjacent to an outlet or mouth of reservoir 534. In one implementation, pump 540 is an inertial pump. In one implementation, pump 540 is an inertial pump utilizing a thermal resistor as a fluid actuator. Pump 540 draws fluid from reservoir 534 to form a stream of fluid flowing along microfluidic channel 36, across sensor elements 532.

Controller 560 is similar to controller 260 described above except that controller 560 receives signals from sensor elements 532 and determines the presence of or absence of a bubble 37 in the flow or stream of fluid based upon impedance changes as indicated by signals from the electrodes 572. As with controller 260, controller 560 utilizes the detected presence or absence of a bubble at each of sensor elements 532 to trigger changes in the operational state of fluid device 250. As with controller 260, controller 560 may calculate a fluid flow rate and adjust the operational status of fluid device 250, bubble generator 528 and/or pump 540 based upon the determined fluid flow rate. In some implementations, controller 560 may adjust the operation of sensor elements 532 based upon the determined flow rate or based upon the presence or absence of a bubble. For example, upon sensor element 532A indicating the presence of a bubble, controller 560 may initiate polling of sensor element 532B for a predefined window of time.

FIG. 7 schematically illustrates portions of an example fluidic die 610. Fluidic die 610 is similar to fluidic die 510 except that fluidic die 610 comprises sensor elements 632A and 632B (collectively referred to as sensor elements 632) in place of sensor elements 532. Those remaining components of fluidic die 610 which correspond to components of fluidic die 510 are numbered similarly.

Sensor elements 632 each comprise an impedance sensor. Unlike the impedance sensors 532, sensor 632 have electrodes extending on or adjacent to opposite surfaces of microfluidic channel 36. In the example illustrated, each of sensor elements 632 comprises a high side electrode 672 on a first surface of channel 36 and a low side electrode 674 on an opposite surface of channel 36. In one implementation, the low side electrodes 674 may be grounded. In another implementation, both electrodes may be differently biased. Although high side electrodes 672 are illustrated as being on one surface while low side electrodes 674 illustrated as being on an opposite surface, in other implementations, the high side electrode 672 of one of sensor elements 632 and the low side electrode 674 of the other sensor elements 632 may be located on the same surface of channel 36. In one implementation, each of such electrodes 672, 674 has a length extending in the direction in which channel 36 extends of between 20% of the diameter of bubble 37 and no greater than two times the diameter of bubble 37. Each of such electrodes 672, 674 may have various shapes such as thin strip lines, rectangles, triangles facing one another and so forth.

FIG. 8 schematically illustrates portions of an example fluidic die 710. Fluidic die 710 is similar to fluidic die 510 except that fluidic die 610 comprises sensor elements 732A and 732B (collectively referred to as sensor elements 732) in place of sensor elements 532. Those remaining components of fluidic die 710 which correspond to components of fluidic die 510 are numbered similarly.

Sensor elements 732 each comprise a pair of impedance sensors that share a single low side electrode. Sensor elements 732 comprises high side electrodes 772-1 and 772-2 which share or cooperate with low side electrode 774 to form two electric fields which may be interrupted by bubble 37 causing the impedance within the individual high side electrodes 772-1 and 772-2 to change. The pair of high side electrodes facilitate a larger overall sensing zone while maintaining signal strength. In the example illustrated, each of electrodes 772-1, 772 -2 and 774 formed on a same surface of channel 36. In other implementations, low side electrodes 774A may be formed on a surface opposite to the surface containing or supporting electrodes 772-1 and 772-2.

FIGS. 9 and 10 schematically illustrate portions of an example fluidic die 810. FIG. 9 is a top view of die 810 while 10 is a side sectional view of die 810. Fluidic die 810 is similar to fluidic die 510 except that fluidic die 810 comprises sensor elements 832A, 832B (collectively referred to as sensor elements 832) and controller 860 in place of sensor elements 532 and controller 560, respectively. Those remaining components of fluidic die 810 which correspond to components of fluidic die 510 are numbered similarly.

Sensor elements 832 each comprise a photodetector 872 and a source of light 874. In one implementation, the source of light 874 may comprise a photo emitter. In one implementation, a source of light 874 may comprise ambient light transmitted through translucent or transparent portions overlying or adjacent to channel 36. In one implementation, each of the photo detectors 872 has a length L comparable to the size of bubble 37 for enhanced accuracy and reliability in detecting the presence of bubble 37. In one implementation, the length L is at least 0.2 times the diameter d a bubble 37 and no greater than 2d. In other implementations, photodetectors 872 may have other dimensions.

Controller 860 is similar to controller 560 except that controller 860 identifies the presence or absence of bubble 37 respect to photodetector's 872 based upon electrical signals received from the individual photodetector's 872. As with controllers 260 and 560, controller 860 utilizes the detected presence or absence of a bubble at each of sensor elements 832 to trigger changes in the operational state of fluid device 250. Controller 860 may calculate a fluid flow rate and adjust the operational status of fluid device 250, bubble generator 528 and/or pump 540 based upon the determined fluid flow rate. In some implementations, controller 560 may adjust the operation of sensor elements 832 based upon the determined flow rate or based upon the presence or absence of a bubble. For example, upon sensor element 832A indicating the presence of a bubble, controller 860 may initiate polling of sensor element 832B for a predefined window of time.

FIG. 11 schematically illustrates portions of an example fluidic die 910. Fluidic die 910 is similar to fluidic die 510 except that fluidic die 910 comprises sensor elements 932A, 932B (collectively referred to as sensor elements 932) and controller 960 in place of sensor elements 532 and controller 560, respectively. Those remaining components of fluidic die 910 which correspond to components of fluidic die 510 are numbered similarly.

Sensor elements 932 each comprise a thermal sensor 972 that senses changes in the temperature of the fluid flowing across the sensing zone of the individual thermal sensor 972. In one implementation, each thermal sensor 972 comprises a material that has an electrical resistance that changes in response to temperature changes. In response to the presence of a bubble 37, the temperature of fluid may change, resulting in the thermal sensor experiencing a change in resistance, wherein the change of resistance is sensed to identify the presence of bubble 37. Another example of thermal sensor 972 is a hotwire sensor which, itself, produces heat and detects a temperature response of the fluid to the generated heat. The thermal response of the fluid to the heat generated by the hotwire sensor results in the hotwire sensor experiencing a change in resistance, wherein the change of resistance is sensed to indicate the presence of bubble 37.

Controller 960 is similar to controller 560 except that controller 960 identifies the presence or absence of bubble 37 with respect to thermal sensor 972 based upon electrical signals received from the individual thermal sensors 972. As with controllers 260 and 560, controller 960 utilizes the detected presence or absence of a bubble at each of sensor elements 932 to trigger changes in the operational state of fluid device 250. Controller 960 may calculate a fluid flow rate and adjust the operational status of fluid device 250, bubble generator 528 and/or pump 540 based upon the determined fluid flow rate. In some implementations, controller 960 may adjust the operation of sensor elements 932 based upon the determined flow rate or based upon the presence or absence of a bubble. For example, upon sensor element 932A indicating the presence of a bubble, controller 960 may initiate polling of sensor element 932B for a predefined window of time.

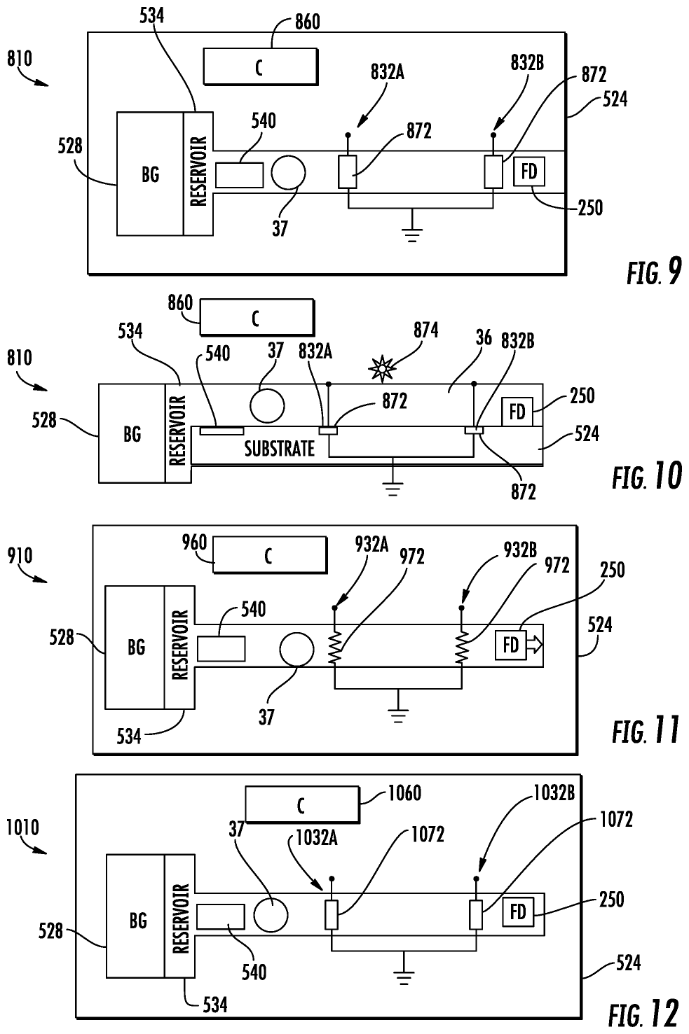

FIG. 12 schematically illustrates portions of an example fluidic die 1010. Fluidic die 1010 is similar to fluidic die 510 except that fluidic die 1010 comprises sensor elements 1032A, 1032B (collectively referred to as sensor elements 1032) and controller 1060 in place of sensor elements 532 and controller 560, respectively. Those remaining components of fluidic die 1010 which correspond to components of fluidic die 510 are numbered similarly.

Sensor elements 1032 each comprise an acoustic sensor 1072 that senses changes in fluid density resulting from a change in the oscillating frequency of the fluid flowing across the sensing zone of the individual acoustic sensor 1072. In one implementation, each thermal sensor 1072 comprises a material that outputs electrical signals in response to sensed vibration or sounds.

Controller 1060 is similar to controller 560 except that controller 1060 identifies the presence or absence of bubble 37 with respect to an individual acoustic sensing element 1072 based upon electrical signals received from the acoustic sensors 872. As with controllers 260 and 560, controller 1060 utilizes the detected presence or absence of a bubble at each of sensor elements 1032 to trigger changes in the operational state of fluid device 250. Controller 1060 may calculate a fluid flow rate and adjust the operational status of fluid device 250, bubble generator 528 and/or pump 540 based upon the determined fluid flow rate. In some implementations, controller 1060 may adjust the operation of sensor elements 1032 based upon the determined flow rate or based upon the presence or absence of a bubble. For example, upon sensor element 1032A indicating the presence of a bubble, controller 1060 may initiate polling of sensor element 1032B for a predefined window of time.

FIG. 13 schematically illustrates portions of an example fluidic die 1110. Fluidic die 1110 utilizes a sensor array to facilitate accurate and timely fluid flow rate detection across a wide range of fluid flow rates. Fluidic die 1110 is similar to fluidic die 510 except that fluidic die 510 additionally comprises sensor element 532C in addition to sensor elements 532A and 532B. Sensor element 532C is similar to sensor element 532A or 532B. Sensor elements 532A and 532C are spaced apart from one another by a first distance while sensor elements 532A and 532B are spaced by a second distance greater than the first distance. In circumstances where the fluid flow rate is low, controller 560 may determine the fluid flow rate using signals from the closer sensors. In circumstances where the fluid for rate is high, controller 560 may determine the fluid flow rate using signals from pairs of sensors that are farther apart, maintaining the timeliness of the determination of fluid flow rate along with the precision across the wide range of fluid flow rates. Controller 560 may determine which signals from which sensor elements to utilize based upon an initial determined fluid flow rate from any of the pair of sensors.

FIG. 14 schematically illustrates portions of an example fluidic die 1210. Fluidic die 1210 is similar to fluidic die 1110 except that fluidic die 1210 comprises a uniformly spaced array 1231 of sensor elements 1232 spaced along microfluidic channel 36. In one implementation, sensor elements 1332 are spaced from one another or have a center to center pitch of between 0.2d and 2d. Those components of fluidic die 1210 which correspond to components of fluidic die 1110 are numbered similarly. In one implementation, each of sensor elements 1232 comprise an impedance sensor similar to sensor elements 532 described above. In other implementations, each of sensor elements 1232 may comprise a sensor element similar to sensor elements 632, 732, 832, 932 or 1032 as described above. In such an implementation, controller 560 may utilize signals from a selected pair or from multiple sensor elements 1232 to determine fluid flow rate. Using signals from a multitude of sensor elements 1232 may reduce errors by providing a redundancy of measurements. The multitude of sensor elements 1232 provide increased precision at low and high flow rates with a fast response and with an increased dynamic range. In addition, signals from the individual sensor elements 1232 may identify the presence of a bubble in the presence of the fluid adjacent the bubble at a multitude of locations, providing a high degree of resolution as to the location of the bubble along microfluidic channel 36. The multitude of sensor elements 1232 may further facilitate continuous tracking of air bubbles and may tolerate more than one bubble 37 in channel 36.

FIG. 15 schematically illustrates portions of an example fluidic die 1310. Fluidic die 1310 is similar to fluidic die 1210 except that fluidic die 1310 comprises an array 1331 of sensor elements 13321-1332n nonuniformly spaced along microfluidic channel 36. In the example illustrated, the array 1331 of sensor elements 1332 are spaced apart in accordance with a logarithmic scale, providing enhanced precision and response rates for both low and high flow rates. In one implementation, sensor elements 1332n-1 and 1332n have a spacing of between 1.0d and 10d while sensor elements 1332-1 and 1332-2 have a spacing of between 0.1d and 1.0d. Those components of fluidic die 1210 which correspond to components of fluidic die 1110 are numbered similarly. In one implementation, each of sensor elements 1332 comprise an impedance sensor similar to sensor elements 532 described above. In other implementations, each of sensor elements 1332 may comprise a sensor element similar to sensor elements 632, 732, 832, 932 or 1032 as described above. In such an implementation, controller 560 may utilize signals from a selected pair or from multiple sensor elements 1332 to determine fluid flow rate. Using signals from a multitude of sensor elements 1332 may reduce errors by providing a redundancy of measurements. In addition, signals from the individual sensor elements 1332 may identify the presence of a bubble and the presence of the fluid adjacent the bubble at a multitude of locations, providing a high degree of resolution as to the location of the bubble along microfluidic channel 36.

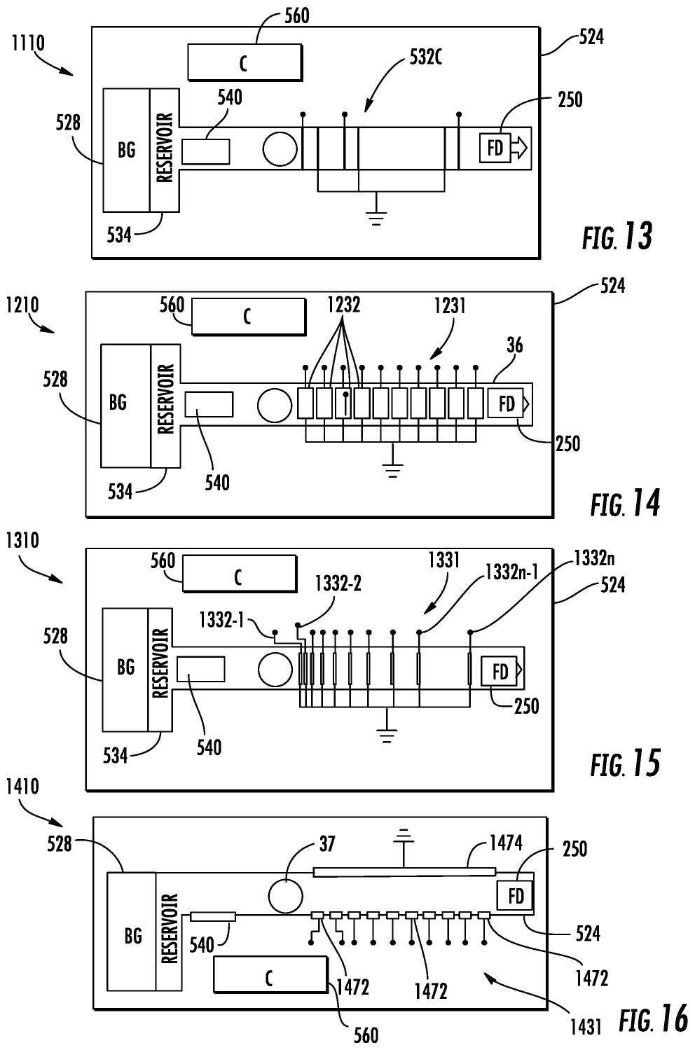

FIG. 16 is a sectional view schematically illustrating portions of an example fluidic die 1410. Fluidic die 1410 is similar to fluidic die 1210 except that fluidic die 1610 comprises an array 1431 of sensor elements 1432 spaced along microfluidic channel 36. In the example illustrated, each of sensor elements 1432 comprises a high side electrode 1472, wherein all of the high side electrodes 1472 share a single low side electrode 1474. In the example illustrated, the high side electrodes 1472 extend on a first surface of channel 36 while the single low side electrodes 1474 extends on an opposite surface of channel 36. In one implementation, the high side electrodes 1472 are uniformly spaced and have a center to center pitch of between 0.2d and 2.0d. In another implementation, the high side electrodes 1472 may be nonuniformly spaced. For example, electrodes 1472 may be logarithmically arranged similar to the arrangement of sensor elements 1332 in FIG. 15. In such an implementation, the first two electrodes 1472 of the array may have a spacing of between 0.1d and 1.0d while the last two electrodes 1472 of the array may have a spacing of between 1.0d and 10d.

In one implementation, the high side electrode 1472 and the low side electrode 1474 form individual impedance sensors that output electrical signals that may be used to detect the presence or absence of bubble 37. In another implementation, electrodes 1472 and 1474 form individual capacitive sensors that output electrical signals that may be used to detect the presence or absence of bubble 37 at distinct locations along channel 36. Using signals from a multitude of sensor elements 1432 may reduce errors by providing a redundancy of measurements. In addition, signals from the individual sensor elements 1432 may identify the presence of a bubble and the presence of the fluid adjacent the bubble at a multitude of locations, providing a high degree of resolution as to the location of the bubble along microfluidic channel 36.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

1. A microfluidic flow sensor comprising:
a substrate having a microfluidic channel;
a bubble generator to introduce a bubble into fluid that is directed through the microfluidic channel; and
a sensor element along the microfluidic channel and spaced from the bubble generator, wherein the sensor element outputs a signal based upon a sensed passage of the bubble with respect to the sensor element, wherein portions of the microfluidic channel proximate the sensor element have a first size and wherein the bubble generated by the bubble generator has a second size greater than one half the first size.

2. The microfluidic flow sensor of claim 1 further comprising:
a fluid pump to drive the fluid along the microfluidic channel; and
a controller to output control signals controlling the fluid pump based upon the signals from the sensor element.

3. The microfluidic flow sensor of claim 2, wherein the controller outputs a second control signal controlling bubble generation by the bubble generator based upon the signals from the sensor element.

4. The microfluidic flow sensor of claim 3, wherein the second control signal adjusts a frequency at which the bubble generator generates bubbles.

5. The microfluidic flow sensor of claim 3, wherein the second control signal adjusts a size of bubbles generated by the bubble generator.

6. The microfluidic flow sensor of claim 1, wherein the bubble generator comprises a thermal resistive bubble generator.

7. The microfluidic flow sensor of claim 1 further comprising a controller, the controller to determine a flow rate of the fluid based upon a time of creation of the bubble and the signal from the sensor element.

8. The microfluidic flow sensor of claim 1 further comprising:
a second sensor element along the microfluidic channel and spaced upstream from the first sensing element, the second sensor element to output a second signal based upon a sensed passage of the bubble with respect to the second sensor element; and
a controller to determine a flow rate of the fluid based upon the second signal from the second sensor element and the signal from the sensor element.

9. The microfluidic flow sensor of claim 1, further comprising a controller, wherein the controller is to determine a flow rate of the fluid based at least in part upon sensing of the bubble and wherein the controller is to receive a second signal from the sensor element based upon a sensed passage of a second bubble with respect to the sensor element, wherein the controller is to determine a third size of the second bubble based upon the second signal and disregard the second bubble with respect to determining the flow rate of the fluid in response to the determined third size being less than one half the first size.

10. The microfluidic flow sensor of claim 1 further comprising a controller to control the bubble generator to control a size of the bubble and to generate the bubble having the second size and a second bubble having a third size greater than one half the first size and different than the second size, wherein the controller controls at least one of a timing and an order at which the bubble and the second bubble are introduced into the fluid to tag different portions of the fluid.

11. The microfluidic flow sensor of claim 1, wherein the second size of the bubble is at least 80% of the first size.

12. The microfluidic flow sensor of claim 1 comprising:
a second sensor element along the microfluidic passage and spaced from the sensor element on a first side of the sensor element by a first distance, the second sensor element to output a second signal based upon a sensed passage of the bubble with respect to the second sensor element; and
a third sensor element along the microfluidic passage on the first side of the sensor element and spaced from the second sensor element by a second distance different than the first distance, the third sensor element to output a third signal based upon a sensed passage of the bubble with respect to the third sensor element.

13. A method for sensing fluid flow through a microfluidic channel with a microfluidic flow sensor, the method comprising:
generating a bubble and introducing the bubble into a fluid; and
sensing passage of the bubble along the microfluidic channel as part of a stream of the fluid within the microfluidic channel, wherein portions of the microfluidic channel proximate the sensor element have a first size and wherein the bubble generated by the bubble generator is to have a second size greater than one half the first size.

14. The method of claim 13 further comprising determining a flow rate of the fluid along the microfluidic channel based upon the sensed passage of the bubble with respect to a first sensor element and one of (A) a sensed passage of the bubble with respect to a second sensor element spaced from the first of the element and (B) a time of creation of the bubble.

15. A microfluidic flow sensor comprising:
a substrate having a microfluidic channel;
a bubble generator to generate and introduce a bubble into fluid that is directed through the microfluidic channel, the bubble generator comprising an electrical resistor supported by the substrate, wherein the electrical resistor, upon conducting electrical current, generates heat to vaporize portions of the fluid to create a bubble;
a first sensor element along the microfluidic channel downstream the bubble generator the first sensor element to output a first signal based upon a sensed passage of the bubble with respect to the first sensor element;
a second sensor element along the microfluidic channel downstream the bubble generator and upstream the first sensor element, the second sensor element to output a second signal based upon a sensed passage of the bubble with respect to the second sensor element; and
a controller to determine a flow rate of the fluid based upon the first signal from the first sensor element and the second signal from the second sensor element.

16. The microfluidic flow sensor of claim 2 wherein the controller is to determine a size of each bubble provided by the bubble generator, and compare the determined size of each bubble to a predetermined threshold.

17. The microfluidic flow sensor of claim 16 wherein the controller is to:
determine a flow rate of the fluid by disregarding bubbles having a size less than or equal to the predetermined threshold; and
output the control signal based on the determined flow rate.

18. The microfluidic flow sensor of claim 1 further comprising a controller, the controller to determine a time of creation of a first tag corresponding with a first sized bubble of the fluid, and to determine a time of creation of a second tag corresponding with a second sized bubble of the fluid.

19. The microfluidic flow sensor of claim 18, further comprising the controller to identify a start of a portion of the fluid by identifying a signal from the sensor element corresponding with the first tag, and to identify an end of the portion of the fluid by identifying a signal from the sensor element corresponding with the second tag.

20. The microfluidic flow sensor of claim 15, wherein the microfluidic channel includes a constricted region within each of the first sensor element and the second sensor element, and wherein the bubble generator provides a bubble having a controlled size.
